(19) United States
(12) Patent Application Publication
(10) Pub. No.: US 2012/0154407 A1
(43) Pub. Date: Jun. 21, 2012

(54) APPARATUS AND METHOD FOR PROVIDING SIMULATION RESULT AS IMAGE

(75) Inventors: Jin Myoung KIM, Daejeon (KR); Hae Young LEE, Seoul (KR); In Geol CHUN, Seoul (KR); Won Tae KIM, Chungcheongnam-do (KR); Seung Min PARK, Daejeon (KR)

(73) Assignee: Electronics and Telecommunications Research Institute, Daejeon (KR)

(21) Appl. No.: 13/289,384

(22) Filed: Nov. 4, 2011

(30) Foreign Application Priority Data
Dec. 15, 2010 (KR) 10-2010-0128512

(51) Int. Cl. G06T 13/00

(52) U.S. Cl. 345/473

(57) ABSTRACT

Provided are an apparatus and method for providing a simulation result as an image. The method includes performing a simulation of a predetermined system and generating a result log of the simulation, and converting the result log of the simulation into an image on the basis of a database storing a state and operation of a model of the system as image data. Accordingly, a simulation result of a system can be provided without detailed information about the system, an additional application, or a separate storage.

### CLAIM FOR PRIORITY

This application claims priority to Korean Patent Application No. 10-2010-0128512 filed on Dec. 15, 2010 in the Korean Intellectual Property Office (KIPO), the entire contents of which are hereby incorporated by reference.

### BACKGROUND

1. Technical Field

Example embodiments of the present invention relate in general to an apparatus and method for providing a simulation result as an image, and more particularly, to a method of providing a simulation result to a user and an apparatus employing the method.

2. Related Art

Modeling is a method for solving a variety of problems occurring in the real world. In particular, events that cannot be tested in the real world can be tested through modeling and simulation. Modeling can be mainly performed using two methods.

A first method is analytic modeling. An analytic model denotes a model that can be expressed by an equation. In practice, it is generally difficult to find a value of such an analytic model.

A second method is simulation modeling. A simulation model can be expressed by a set of rules such as cellular automata discrete event systems specification (DEVS) formalism.

Simulation is a process in which a state of such a model changes according to time. Using simulation, it is possible to solve various problems occurring in the real world.

Various simulation modeling techniques have been proposed to model a system having a dynamic feature and perform simulation. Among the simulation modeling techniques, a system dynamics technique and discrete event system modeling have been most frequently and widely used.

The system dynamics technique can be mainly expressed by a differential equation. Using connection between a dynamic feature, a decision-making feature, a time-delay feature, etc., of a complex system and a feedback structure of the complex system, results are rapidly estimated according to scenarios, so that an efficient strategy can be established and performed.

In a discrete event system, a state space consists of a limited number of discrete values, instantaneously changes in state at a random time, and stays in one state for an irregular time period.

In particular, the DEVS formalism, which is mathematical formalism for modeling such a discrete event system, provides a modeling framework based on mathematical semantics capable of expressing an operation of a target system.

The greatest difference between the system dynamics technique and the discrete event system modeling is that the system dynamics is used to model a system expressed by one differential equation through a high-level abstraction process and thus mainly applied to an analytic model, and the discrete event system modeling can be applied to various systems through a hierarchical system structure regardless of an abstraction process and mainly used for a simulation model.

### SUMMARY

In general, a result of system simulation is output in the form of a log file. Thus, to examine the simulation result, the log file should be parsed. However, a conventional method of checking such a simulation result additionally requires an application for parsing a simulation result log and showing the parsed result. Thus, when a log file showing a simulation result has a different type than a log file of an application for parsing and showing, the application needs to be additionally modified.

Also, when there are a great number of models of a system to be simulated, or an operation and a state of the system are too long, it is necessary to know operations and states of all the models of the system in order to operate a simulation result. Thus, it may be difficult to distribute the simulation result or transmit the simulation result in real time.

Accordingly, example embodiments of the present invention are provided to substantially obviate one or more problems due to limitations and disadvantages of the related art.

Example embodiments of the present invention provide a method of providing a simulation result using image information without an additional application for examining the simulation result.

Example embodiments of the present invention also provide an apparatus for providing a simulation result using image information without an additional application for examining the simulation result.

In some example embodiments, a method of providing a simulation result as an image includes: performing a simulation of a predetermined system, and generating a result log of the simulation; and converting the result log of the simulation into an image on the basis of a database storing a state and operation of a model of the system as image data. The method may further include generating the model by analyzing the system, and converting the generated model into a model object for performing the simulation. The method may further include generating moving picture information on the basis of the image obtained by converting the result log of the simulation, and performing a streaming service of the moving picture information through a streaming server. The streaming service may stream the image using a hypertext transfer protocol (HTTP) or multimedia messaging service (MMS) protocol. Converting the result log of the simulation into the image on the basis of the database storing the state and operation of the model of the system as the image data may include converting the result log of the simulation into the image by matching model information included in the result log of the simulation with image data stored at a specific address of the database storing the state and operation of the model as the image data. Converting the result log of the simulation into the image on the basis of the database storing the state and operation of the model of the system as the image data may include converting the result log of the simulation into the image by synchronizing image information and audio information included in the simulation result log with each other.

In other example embodiments, an apparatus for providing a simulation result as an image includes: a simulation performer configured to perform a simulation of a predetermined system and provide the simulation result in the form of a log; a model operation and model state database configured to store operation and a state of a model of the system, and match the simulation result log generated by the simulation performer with at least one piece of stored image and voice data; and an image information encoder configured to load the result log generated by the simulation performer and generate image data from the result log. The image information encoder may convert the result log of the simulation into an image by matching model information included in the result log of the simulation provided by the simulation performer with image data stored at a specific address of the model operation and model state database storing the state and operation of the model as image data or audio data. When the simulation result log includes image information and audio information, the image information encoder may convert the result log of the simulation into an image by synchronizing the image information and the audio information with each other. The apparatus may further include: a system analyzer configured to analyze the predetermined system according to an informal specification; a model generator configured to model the predetermined system on the basis of the analysis result of the system analyzer; and a model object converter configured to convert the model generated by the model generator into a model object for performing the simulation. The apparatus may further include a streaming server configured to provide a streaming service of the image data encoded by the image information encoder. The streaming server may stream the image using a HTTP or MMS protocol.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a system for providing a simulation result as image information according to an example embodiment of the present invention;

FIG. 2 is a conceptual diagram illustrating a case of transmitting a simulation result encoded into image information according to an example embodiment of the present invention;

FIG. 3 is a conceptual diagram illustrating a process of encoding a simulation result log in the form of image information according to an example embodiment of the present invention;

FIG. 4 is a flowchart illustrating a method of providing a simulation result in the form of a moving picture according to an example embodiment of the present invention;

FIG. 5 is a conceptual diagram illustrating a method of providing a simulation result in the form of a moving picture according to an example embodiment of the present invention;

FIG. 6 is a conceptual diagram illustrating a method of generating a simulation result as image information according to an example embodiment of the present invention; and

FIG. 7 is a conceptual diagram illustrating a method of providing a streaming service of a simulation result according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described with reference to the appended drawings.

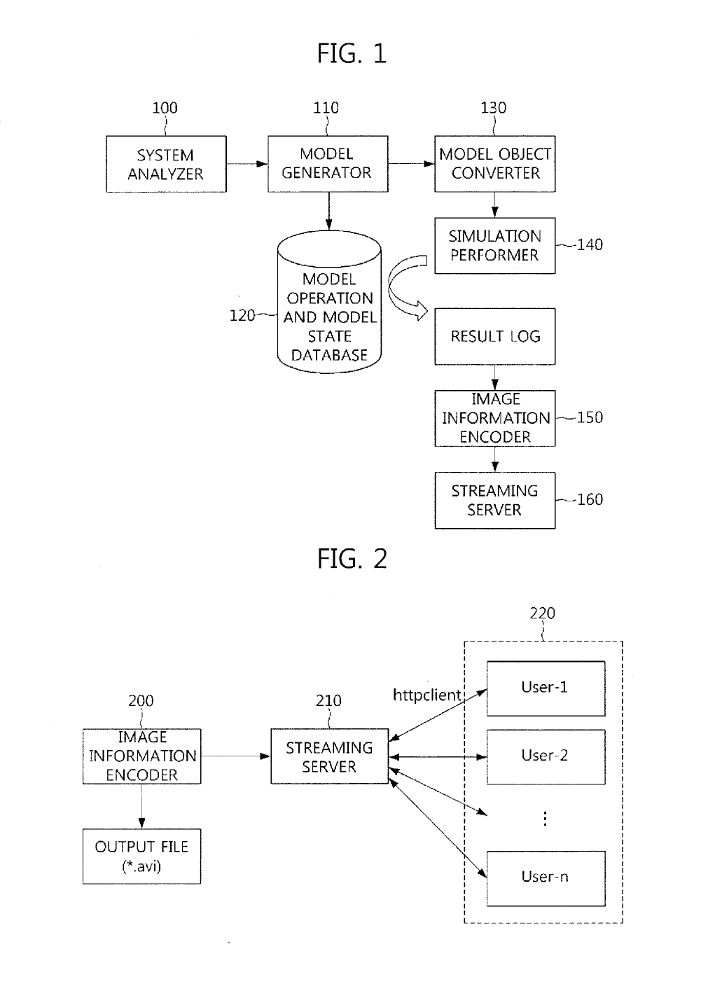

FIG. 1 is a conceptual diagram of a system for providing a simulation result in the form of image information according to an example embodiment of the present invention. Referring to FIG. 1, a system for providing a simulation result in the form of image information may include a system analyzer 100, a model generator 110, a model operation and model state database 120, a model object converter 130, a simulation performer 140, an image information encoder 150, and a streaming server 160.

The respective components are separately listed for convenience of description. At least two of the components may be combined into one component, or one component may be divided into a plurality of components to perform a function. Example embodiments in which the components are combined or divided are also included in the scope of the present invention as long as the embodiments do not deviate from the spirit of the present invention.

Also, some components may be optional components merely for improving performance rather than essential components that perform a fundamental function of the present invention. Example embodiments of the present invention may only include the components essential to implement the spirit of the present invention without the components merely used for improving performance, and a structure only including the essential components without the optional components merely used for improving performance is also included in the scope of the present invention.

The system analyzer 100 may analyze a system according to an informal specification.

In an example embodiment of the present invention, an informal specification is a method for analyzing a system. A method of analyzing a system to be simulated not in accordance with an informal specification but in another way is also included in the scope of the present invention as long as the method does not deviate from the spirit of the present invention.

The model generator 110 may model the system on the basis of the analysis result of the system analyzer 100.

The model operation and model state database 120 may store operation and a state of a model obtained by modeling the system in a database as results of modeling the system. In other words, operation and states of respective models obtained by modeling the system may be stored in the model operation and model state database 120 in the form of raw data.

Also, when there is audio data for the models obtained by modeling the system, the audio data may be additionally stored.

Audio data and video data stored in the model operation and model state database 120 may be synchronized and provided as a simulation result.

Audio data and video data may be synchronized based on simulation time through an audio/video (A/V) data encoding process. The synchronized audio data and video data may be mixed by an A/V mixer.

The model object converter 130 may convert the models into model objects for performing simulation.

The model objects generated by the model object converter 130 may be converted into an appropriate form to be input to the simulation performer 140.

The simulation performer 140 may perform simulation on the basis of the provided model objects, and provide the simulation result in the form of a log file. The image information encoder 150 may encode the results generated by the simulation performer 140 into an image information format such as a YUV format including brightness information and chrominance information.

The simulation result logs generated by the simulation performer 140 may be mapped to predeteimined image information stored in the model operation and model state database 120.

In other words, the image information encoder 150 may load the simulation result logs, thereby obtaining information about the respective models from the model operation and model state database 120.

In the simulation result logs, operations, states, etc. of the models during a simulation time period are defined. Such a simulation log may be matched with image information stored in the model operation and model state database 120. In other words, a specific simulation result log may be matched with specific video data and audio data stored at a specific address of the database 120.

The image information encoder 150 may generate image information data in the form of a moving picture from a time-based simulation result using matched image information.

In an example embodiment of the present invention, the YUV format provides a simulation result using image information in the form of an image or moving picture. A format capable of expressing image information other than the YUV format for providing a simulation result in the form of a moving picture may be used as long as the format does not deviate from the spirit of the present invention.

An encoded simulation result has the same format as a general moving picture file (e.g., *.avi, *.asf, or *.wmv), and thus enables play, stop, pause, fast-forward, and drag & play that can be used for general moving picture files. Thus, when a client plays a simulation result, it is convenient to control the simulation result.

The streaming server 160 may provide the result encoded by the image information encoder 150 using a streaming service.

The simulation result may be provided in the form of a general moving picture file, or using a method of providing a streaming service based on a streaming server.

To examine a simulation result at a client connected with a server, a user may be provided with the simulation result using a server-based streaming service. In an example embodiment of the present invention, a streaming service provides a simulation result. A simulation result may be provided to a client in various ways such as downloading, which are also included in the scope of the present invention as long as the ways do not deviate from the spirit of the present invention.

A conventional method of seeing a simulation result additionally requires an application for parsing the simulation result in the form of a log file and showing the simulation result on the basis of the parsed result. Thus, when the log file showing the simulation result has a different type than a log file of an application for parsing and showing, a parsing application is additionally needed.

Also, when there are a great number of models of a system to be simulated, or an operation and a state of the system are too long, it is necessary to know operations and states of all the models of the system in order to operate a simulation result. Thus, it is difficult to distribute the simulation result or transmit the simulation result in real time.

However, in an example embodiment of the present invention, a simulation result log may be encoded in the form of image information so that the simulation result log can be provided as a moving picture file or by a streaming service using a streaming server without parsing a simulation result log file, and the simulation result in the form of a moving picture may be provided.

In other words, an application for parsing a log file conventionally used to examine a simulation result is not needed, and thus the simulation result may be directly examined. Also, even when a user does not know operations and states of all models of a system, he/she can readily examine the simulation result.

FIG. 2 is a conceptual diagram illustrating a case of transmitting a simulation result encoded into image information according to an example embodiment of the present invention.

Referring to FIG. 2, first, a streaming service of a simulation result encoded in the faun of image information may be provided in a network using a moving picture file or a transmission protocol such as hypertext transfer protocol (HTTP).

An image information encoder 200 may provide a simulation result log transferred from a simulation performer 140 in a moving picture file format (e.g., *.avi, *.asf, or *.wmv).

On the basis of the moving picture file format (e.g., *.avi, *.asf, or *.wmv) into which the simulation result log is converted by the image information encoder 200, a streaming service of the simulation result may be provided to a plurality of clients 220 through a streaming server 210.

In other words, using a method of converting a simulation result in the form of image information according to an example embodiment of the present invention, a simulation result may be distributed without an additional application and thus readily provided to many people.

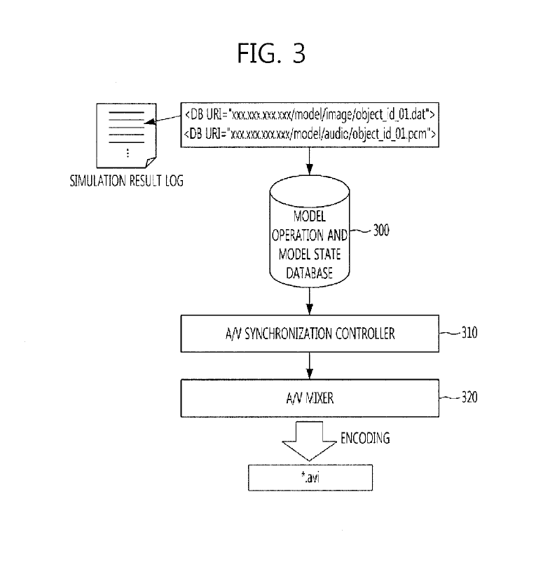

FIG. 3 is a conceptual diagram illustrating a process of encoding a simulation result log in the form of image information according to an example embodiment of the present invention.

Referring to FIG. 3, an image information encoder 150 may obtain information about each model from a model operation and model state database 300 by loading a simulation result log. In the model operation and model state database 300, model information may be stored in the form of raw data.

In other words, a specific simulation result log may be matched with specific video data and audio data included in a specific address (e.g., <DB URI=“xxxx.xxx.xxx.xxx/model/image/object_id_{—}01.dat”> and <DB URI=“xxxx.xxx.xxx.xxx/model/audio/object_id_{—}01.pcm”>) of the model state and model operation database 300.

Video data and audio data may be generated on the basis of the result log generated by a simulation performer.

In this case, an A/V synchronization controller 310 may provide a simulation result by synchronizing the audio data and the video data.

At this time, synchronization may be performed based on simulation time, and the audio data and the video data may be synchronized in an A/V data encoding process.

An A/V mixer 320 may mix the audio and video data synchronized by the A/V synchronization controller 310.

An encoded simulation result has the same format as a general moving picture file (e.g., *.avi, *.asf, or *.wmv), and thus enables play, stop, pause, fast-forward, and drag & play that can be used for general moving picture files. Thus, when a client plays the simulation result, it is convenient to control the simulation result.

In an example embodiment, a simulation result may be provided in the form of a moving picture file obtained by combining video and audio data, and thus no additional application is needed, unlike a conventional method for examining a simulation result.

Also, respective users may examine simulation results distributed in real time without knowing operations and states of all models.

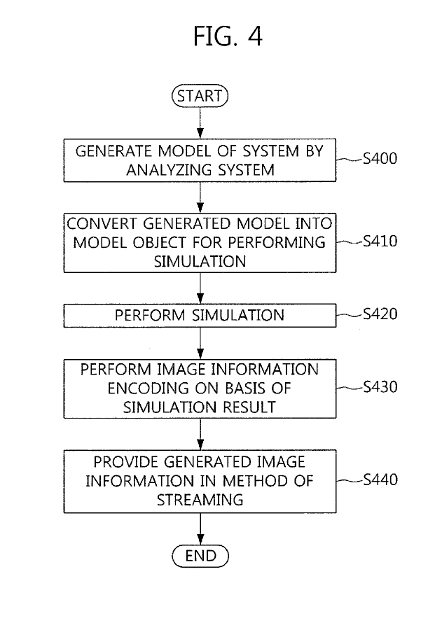

FIG. 4 is a flowchart illustrating a method of providing a simulation result in the form of a moving picture according to an example embodiment of the present invention.

Referring to FIG. 4, a model of a system to be simulated may be generated by analyzing the system (S400).

The system to be simulated may be analyzed according to an informal specification.

In an example embodiment of the present invention, a method of analyzing a system to be simulated other than the method of analyzing a system according to an informal specification is also included in the scope of the present invention as long as the method does not deviate from the spirit of the present invention.

The analyzed system may be modeled on the basis of the analysis result. An operation and a state of the model may be stored in a database in the form of raw data.

When the model requires audio data, audio data may be additionally stored.

The generated model may be converted into a model object for performing simulation (S410).

The generated model may be converted into a model object to perform simulation.

Simulation may be performed on the basis of the model object (S420).

Simulation may be performed using the model object, and a log may be generated as a simulation result value.

Image information encoding may be performed on the basis of a result log value that is the simulation result (S430).

A simulation result log may be generated in the form of a moving picture file that is image information. For example, images compressed into Joint Photographic Experts Group (JPEG) files are decompressed and then converted in the form of image information, and the converted images are changed into one video file and compressed, so that a moving picture file can be generated.

A simulation result log has state and operation information about models based on simulation time, and the information may be stored in a model state and model operation database in the form of images. Thus, using images stored in the model state and model operation database, it is possible to know operation of models according to time.

A moving picture file may be generated, and a streaming service of the moving picture may be provided through a streaming server (S440).

In an example embodiment of the present invention, a streaming service provides a simulation result. A simulation result may be provided to a client in various ways such as downloading, which are also included in the scope of the present invention as long as the ways do not deviate from the spirit of the present invention.

In an example embodiment of the present invention, moving picture data may be generated on the basis of image information about a simulation environment and an object model according to time. The generated moving picture data may be transmitted through a network-based streaming server, so that a simulation result can be examined at a remote site without an additional application. Also, even a very large amount of simulation data is transmitted via a network in a streaming method, and thus it is possible to provide a simulation result without storing the simulation result in a terminal of a client.

Using a device such as an image information encoder 150, a simulation result log generated by a simulation performer 140 may be provided in a moving picture file format (e.g., *.avi, *.asf, or *.wmv). Also, on the basis of the simulation result log converted into the moving picture file format by the device such as the image information encoder 150, a streaming service of a simulation result may be provided to a plurality of clients through a streaming server.

In other words, in an example embodiment of the present invention, a simulation result may be distributed without an additional application and thus readily provided to many clients.

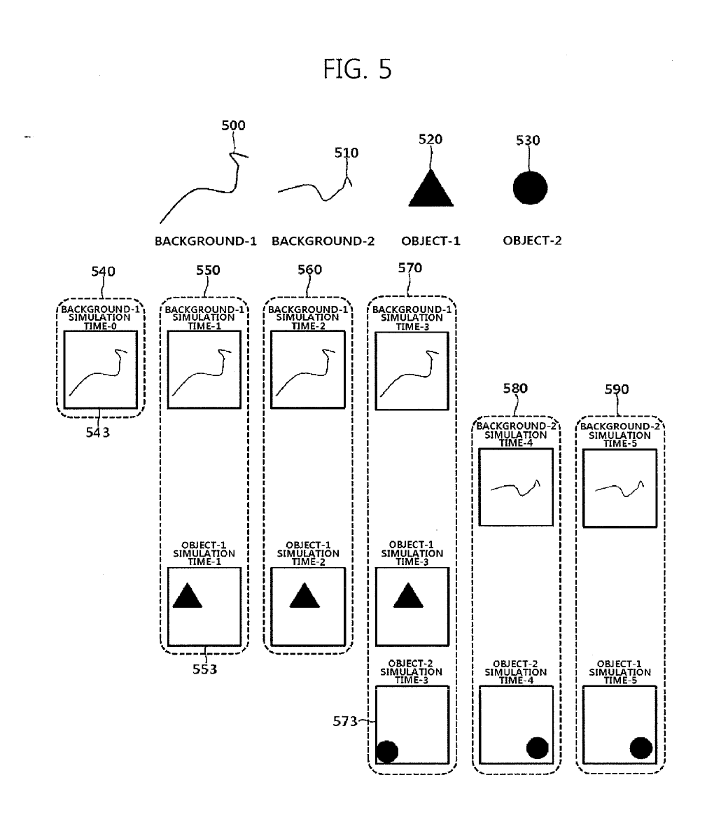

FIG. 5 is a conceptual diagram illustrating a method of providing a simulation result in the form of a moving picture according to an example embodiment of the present invention.

A method of providing a simulation result in the form of a moving picture according to an example embodiment of the present invention is merely an example, and a simulation result may be provided in the form of a moving picture using, for example, another object, another coordinate axis, or another combination method as long as the resultant method does not deviate from the spirit of the present invention.

Table 1 below shows simulation results.

TABLE 1

| Artificial Time (AT) | Name (N) | Location (L) | State (S) |
|---|---|---|---|
| at which Simulation is | of Object or | of Object or | of Object or |
| Performed | Background | Background | Background |
| 0 | Background-1 | 0, 0, 0 | Background |
| 1 | Object-1 | 2, 7, 1 | Addition |
| 2 | Object-1 | 5, 7, 1 | • |
| 3 | Object-1 | 5, 7, 1 | • |
| 3 | Object-2 | 1, 1, 1 | Addition |
| 4 | Background-2 | 0, 0, 0 | Background |
| 4 | Object-2 | 10, 1, 1 | • |
| 4 | Object-1 | 5, 7, 1 | Hidden |
| 5 | Object-1 | 10, 1, 1 | • |

Artificial time (AT) at which simulation is performed enables sequential provision of simulation results. Names (N) of objects or backgrounds are names of objects or backgrounds stored in a model state and model operation database.

To play a—simulation result, the corresponding images may be divided into backgrounds and objects. A state and location of a background or object may vary according to time.

Coordinates of an object may vary as simulation is performed. For example, when at least one of an X coordinate and a Y coordinate varies, the corresponding object may move in a screen providing a simulation result. Also, when a Z coordinate varies, the object may decrease in size to express perspective. Furthermore, when coordinates of objects overlap each other, an object having a relatively small Z coordinate value may be shown on the screen, and an object having a relatively large Z coordinate value may be concealed not to be shown on the screen.

Location (L) of an object or background is information indicating how the object or background moves along the X, Y and Z coordinate axes according to time.

State (S) of an object or background is information indicating in which state the object or background is during the corresponding simulation.

In the case of a background, a state of background may include background information that the background does not move and is fixed. “Addition” denotes that the corresponding object needs to be added to show a simulation result, and “Hidden” denotes that the corresponding object is covered by another object and is not currently shown.

The upper part of FIG. 5 shows objects and backgrounds stored in a model state and model operation database.

Background-1 500, background-2 510, object-1 520, and object-2 530 are shown from left to right in sequence.

The lower part of FIG. 5 shows time-varying objects and backgrounds stored in the model state and model operation database without combining the objects and the backgrounds.

The progress of states of the backgrounds and the objects is shown from left to right in simulation time units.

Referring to Table 1, background-1 543 exists at simulation time-0, and this state is shown at simulation time-0 540 in the lower portion of FIG. 5.

At simulation time-1 550, object-1 553 may be added to a position of (X,Y,Z)=(2,7,1). At simulation time-2 560, object-1 553 moves to a position of (X,Y,Z)=(5,7,1) and has no additional motion.

At simulation time-3 570, object-2 573 is added to a position of (X,Y,Z)=(1,1,1), and object-1 553 may be stopped at the position of (X,Y,Z)=(5,7,1).

At simulation time-4 580, background-2 583 may be added. When background-2 583 is added, existing background-1 543 may be removed, and background-2 583 may appear as a new background. Object-2 573 moves from the position of (X,Y,Z)=(1,1,1) to a position of (X,Y,Z)=(10,1,1), and object-1 553 may be concealed.

In the above-described method, the corresponding object and background may be combined into one piece of image information, and a simulation result may be provided through such image information without a specific application for showing a simulation result.

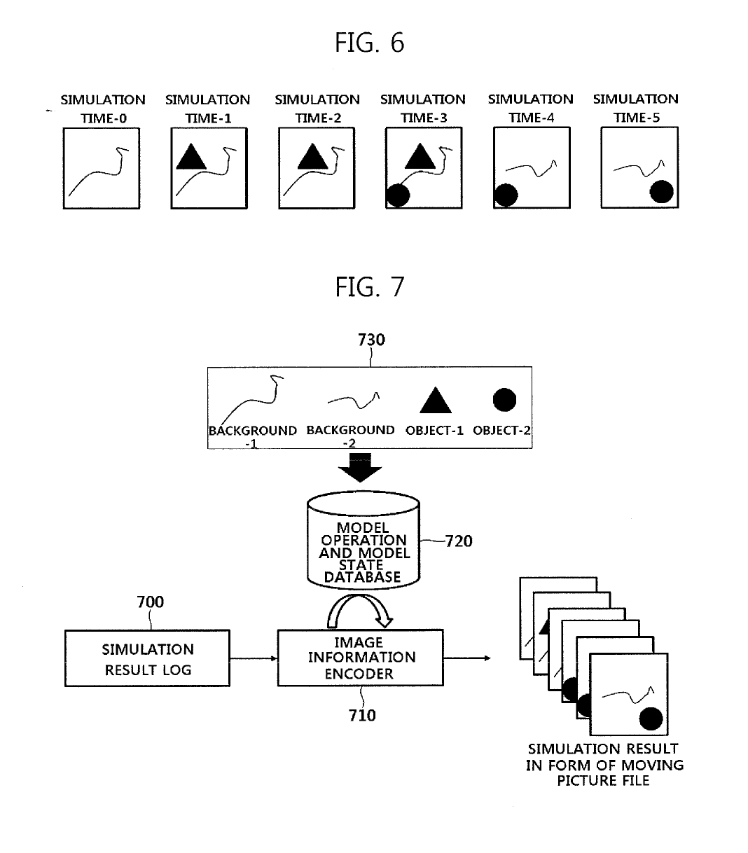

FIG. 6 is a conceptual diagram illustrating a method of generating a simulation result as image information according to an example embodiment of the present invention.

Referring to FIG. 6, objects separated according to simulation time in FIG. 5 are combined into images.

One piece of moving picture information may be generated from these combined images according to time. Such moving picture information may be downloaded in the form of a file or provided in real time by a streaming method. When such a method of providing a simulation result is used, a matching operation based on a model operation and model state database is performed before a simulation result is examined, and thus a receiving side may be provided with the simulation result without a database.

FIG. 7 is a conceptual diagram illustrating a method of providing a streaming service of a simulation result according to an example embodiment of the present invention.

Referring to FIG. 7, a simulation result log 700 may be provided to an image information encoder 710. The provided simulation result log 700 may be matched with objects and backgrounds 730 stored in a model operation and model state database 720.

On the basis of the result of matching the objects and backgrounds 730 stored in a model operation and model state database 720 with the simulation result log 700, a moving picture encoder may generate image information.

The generated image information may be provided in the form of a file, and a streaming service of the simulation result may be provided through a streaming server.

Using an apparatus and method for providing a simulation result according to example embodiments of the present invention, it is possible to convert a log file generated as a simulation result in the form of image information.

Consequently, a simulation result of a system can be provided without detailed information about the system, an additional application, or a separate storage.

While the example embodiments of the present invention and their advantages have been described in detail, it should be understood that various changes, substitutions and alterations may be made herein without departing from the scope of the invention.

What is claimed is:

1. A method of providing a simulation result as an image, comprising:
performing a simulation of a predetermined system, and generating a result log of the simulation; and
converting the result log of the simulation into an image on the basis of a database storing a state and operation of a model of the system as image data.

2. The method of claim 1, further comprising generating the model by analyzing the system, and converting the generated model into a model object for perfoiming the simulation.

3. The method of claim 1, further comprising generating moving picture information on the basis of the image obtained by converting the result log of the simulation, and performing a streaming service of the moving picture information through a streaming server.

4. The method of claim 3, wherein the streaming service streams the image using a hypertext transfer protocol (HTTP) or multimedia messaging service (MMS) protocol.

5. The method of claim 1, wherein converting the result log of the simulation into the image on the basis of the database storing the state and operation of the model of the system as the image data includes converting the result log of the simulation into the image by matching model information included in the result log of the simulation with image data stored at a specific address of the database storing the state and operation of the model as the image data.

6. The method of claim 1, wherein converting the result log of the simulation into the image on the basis of the database storing the state and operation of the model of the system as the image data includes converting the result log of the simulation into the image by synchronizing image information and audio information included in the simulation result log with each other.

7. An apparatus for providing a simulation result as an image, comprising:
a simulation performer configured to perform a simulation of a predetermined system and provide the simulation result in the form of a log;
a model operation and model state database configured to store operation and a state of a model of the system, and match the simulation result log generated by the simulation performer with at least one piece of stored image and voice data; and
an image information encoder configured to load the result log generated by the simulation performer and generate image data from the result log.

8. The apparatus of claim 7, wherein the image information encoder converts the result log of the simulation into an image by matching model information included in the result log of the simulation provided by the simulation performer with image data stored at a specific address of the model operation and model state database storing the state and operation of the model as image data or audio data.

9. The apparatus of claim 7, wherein, when the simulation result log includes image information and audio information, the image information encoder converts the result log of the simulation into an image by synchronizing the image information and the audio information with each other.

10. The apparatus of claim 7, further comprising:
a system analyzer configured to analyze the predetermined system according to an informal specification;
a model generator configured to model the predetermined system on the basis of the analysis result of the system analyzer; and
a model object converter configured to convert the model generated by the model generator into a model object for performing the simulation.

11. The apparatus of claim 7, further comprising a streaming server configured to provide a streaming service of the image data encoded by the image information encoder.

12. The apparatus of claim 11, wherein the streaming server streams the image using a hypertext transfer protocol (HTTP) or multimedia messaging service (MMS) protocol.
